(19) United States
(12) Patent Application Publication
(10) Pub. No.: US 2021/0079026 A1
(43) Pub. Date: Mar. 18, 2021

(54) SILICON COMPOUND, PREPARATION METHOD THEREOF AND LITHIUM BATTERY

(71) Applicant: National Taiwan University of Science and Technology, Taipei (TW)

(72) Inventors: Fu-Ming Wang, Taipei (TW); Quoc Thai Pham, Taipei (TW); Alem Gebrelibanos Hailu, Taipei (TW); Arif Cahyo Imawan, Taipei (TW)

(73) Assignee: National Taiwan University of Science and Technology, Taipei (TW)

(21) Appl. No.: 16/820,709

(22) Filed: Mar. 17, 2020

(30) Foreign Application Priority Data
Sep. 16, 2019 (TW) 108133150

(51) Int. Cl. C07F 7/08; H01M 10/0525; H01M 10/0567; H01M 10/0569; H01M 10/0568; H01M 4/60

(52) U.S. Cl. CPC C07F 7/0879; H01M 10/0525; H01M 4/60; H01M 10/0569; H01M 10/0568; H01M 10/0567

(57) ABSTRACT

A silicon compound, a preparation method thereof, and a lithium battery are provided. The silicon compound is represented by the following Chemical formula 1:

(R¹)₄₋ₙ—Si-(L-A)ₙ [Chemical formula 1]

In Chemical formula 1, each substituent is defined the same as in the specification.

### CROSS-REFERENCE TO RELATED APPLICATION

This application claims the priority benefit of Taiwan application serial no. 108133150, filed on Sep. 16, 2019. The entirety of the above-mentioned patent application is hereby incorporated by reference herein and made a part of this specification.

### BACKGROUND OF THE INVENTION

### Field of the Invention

The invention relates to a silicon compound, a preparation method thereof, and a battery, and more particularly, to a silicon compound for a lithium battery, a preparation method thereof, and a lithium battery.

### Description of Related Art

Since silicon has a very high energy density (4000 mAh/g) and high global reserves, silicon has always been a material that science and industry are eager to commercialize. However, except for the fact that the reaction mechanism between silicon and lithium ions is very different from the reaction mechanism between graphite and lithium ions, the alloy volume expansion after the reaction between silicon and lithium is rapid, thus causing the material to be readily cracked. The above issue occurs repeatedly after the resulting cracked surface is reacted with an electrolyte solution, eventually resulting in a poor cycle life of the material, and thus limiting the current applicability of silicon materials.

There are many research and development directions to improve the above disadvantages, such as using new electrolyte additives (such as fluoroethylenecarbonate (FEC)), new adhesive systems (such as polyimide (PI)), or alloy series (such as silicon tin). However, none of the above improvement methods may completely improve the above disadvantages.

### SUMMARY OF THE INVENTION

The invention provides a silicon compound that may be applied to an anode material of a lithium battery, such that the lithium battery has good battery life.

The invention provides a preparation method of a silicon compound, and the silicon compound prepared thereby may be applied to an anode material of a lithium battery, such that the lithium battery has good battery life.

The invention provides a lithium battery having the silicon compound.

The invention provides a silicon compound represented by the following Chemical formula 1:

(R¹)₄₋ₙ—Si-(L-A)ₙ [Chemical formula 1]

in Chemical formula 1,

L is a linker,

A is a carboxyl group,

R¹ is each independently hydrogen, a halogen atom, an alkyl group, an aryl group, an alkoxy group, or a hydroxyl group,

n is an integer of 0 to 4,

when n is greater than or equal to 2, L may be the same or different group.

In an embodiment of the invention, the linker is, for example, an alkylene group, an arylene group, a heteroarylene group, an alkyleneoxy group, a cycloalkylene group, an amide group, a carbonyloxy group, a divalent group having a halogen, or a combination thereof.

The invention provides a preparation method of a silicon compound including the following steps. First, an olefin reactant is provided. Next, the olefin reactant is connected to a silicon reactant via a hydrosilylation reaction to obtain the silicon compound. The silicon reactant has at least one silane functional group, wherein the olefin reactant includes a terminal olefin functional group, a terminal carboxyl group, and a linker connected to the terminal olefin functional group and the terminal carboxyl group.

In an embodiment of the invention, the silicon reactant is represented by (R)₄₋ₙ—Si—(H)ₙ, wherein R is each independently a halogen atom, an alkyl group, an aryl group, an alkoxy group, or a hydroxyl group, and n is an integer of 1 to 4.

In an embodiment of the invention, the linker is, for example, an alkylene group, an arylene group, a heteroarylene group, an alkyleneoxy group, a cycloalkylene group, an amide group, a carbonyloxy group, a divalent group having a halogen, or a combination thereof.

In an embodiment of the invention, the olefin reactant is, for example, (meth)acrylic acid, acrylic acid, or carboxyethyl acrylate.

The invention provides a preparation method of a silicon compound including the following steps. First, a first olefin reactant is provided. Next, the first olefin reactant is connected to a silicon reactant via a hydrosilylation reaction to obtain an intermediate compound. Next, a second olefin reactant is brought in contact with the intermediate product such that the second olefin reactant is connected to the intermediate product to obtain the silicon compound. The silicon reactant has at least one silane functional group, wherein the first olefin reactant includes a first terminal olefin functional group, a group capable of reacting with the olefin functional group, and a first linker connected to the first terminal olefin functional group and the group capable of reacting with the olefin functional group, and the second olefin reactant includes a second terminal olefin functional group, a terminal carboxyl group, and a second linker connected to the second terminal olefin functional group and the terminal carboxyl group.

In an embodiment of the invention, the silicon reactant is represented by (R)₄₋ₙ—Si—(H)ₙ, wherein R is each independently a halogen atom, an alkyl group, an aryl group, an alkoxy group, or a hydroxyl group, and n is an integer of 1 to 4.

In an embodiment of the invention, the first linker is, for example, an alkylene group, an arylene group, a heteroarylene group, an alkyleneoxy group, a cycloalkylene group, an amide group, a carbonyloxy group, a divalent group having a halogen, or a combination thereof.

In an embodiment of the invention, the second linker is, for example, an alkylene group, an arylene group, a heteroarylene group, an alkyleneoxy group, a cycloalkylene group, an amide group, a carbonyloxy group, a divalent group having a halogen, or a combination thereof.

In an embodiment of the invention, the group capable of reacting with the olefin functional group is, for example, an alkyl halide group.

In an embodiment of the invention, the first olefin reactant is, for example, allyl-2-bromo-2-methylpropionate.

In an embodiment of the invention, the second olefin reactant is, for example, (meth)acrylic acid, acrylic acid, or carboxyethyl acrylate.

Based on the above, when the silicon compound of the invention is used as an anode material of a lithium battery, and a polymer brush grafted on the silicon compound of the invention may be used as an elastomer, the expansion after the reaction between silicon and lithium may be suppressed and the issue of material cracking may be reduced. In addition, the polymer brush grafted on the silicon compound of the invention may prevent excessive contact with an electrolyte solution, thereby reducing the issue of forming too many passive films due to electrolyte solution pyrolysis. Therefore, the internal resistance of the battery may be significantly reduced, thereby improving the life of lithium batteries.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional diagram of a lithium battery according to an embodiment of the invention.

FIG. 2 is a life cycle diagram of the lithium batteries of Experimental example 4 and Comparative example 1.

FIG. 3 is a life cycle diagram of the lithium battery of Experimental example 5.

FIG. 4 is a life cycle diagram of the lithium batteries of Experimental example 6 and Comparative example 1.

### DESCRIPTION OF THE EMBODIMENTS

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with the any numerical value and the smaller numerical range stated explicitly in the specification.

In order to prepare a high-energy silicon material that may be applied to an anode material of a lithium battery such that the lithium battery has good performance, the invention provides a silicon compound that may achieve the above advantage. In the following, embodiments are provided to describe actual implementations of the invention.

[Silicon Compound of Invention]

An embodiment of the invention provides a silicon compound represented by the following Chemical formula 1:

(R¹)₄₋ₙ—Si-(L-A)ₙ [Chemical formula 1]

in Chemical formula 1,

L is a linker,

A is a carboxyl group,

R¹ is each independently hydrogen, a halogen atom, an alkyl group, an aryl group, an alkoxy group, or a hydroxyl group,

n is an integer of 0 to 4,

when n is greater than or equal to 2, L may be the same or different group.

In an embodiment of the invention, the linker includes an alkylene group, an arylene group, a heteroarylene group, an alkyleneoxy group, a cycloalkylene group, an amide group, a carbonyloxy group, a divalent group having a halogen, or a combination thereof.

In an embodiment, the linker is, for example, a C1 to C12 alkylene group, a C6 to C15 arylene group, a C2 to C12 heteroarylene group, a C1 to C12 alkyleneoxy group, a C3 to C12 cycloalkylene group, an amide group, a carbonyloxy group, or a divalent group having a halogen, but the invention is not limited thereto.

[Preparation Method of Silicon Compound of the Invention]

The first embodiment of the invention provides a preparation method of a silicon compound including the following steps. First, an olefin reactant is provided, wherein the olefin reactant includes a terminal olefin functional group, a terminal carboxyl group, and a linker connected to the terminal olefin functional group and the terminal carboxyl group.

In an embodiment, the linker includes an alkylene group, an arylene group, a heteroarylene group, an alkyleneoxy group, a cycloalkylene group, an amide group, a carbonyloxy group, a divalent group having a halogen, or a combination thereof.

In an embodiment, the linker is, for example, a C1 to C12 alkylene group, a C6 to C15 arylene group, a C2 to C12 heteroarylene group, a C1 to C12 alkyleneoxy group, a C3 to C12 cycloalkylene group, an amide group, a carbonyloxy group, or a divalent group having a halogen, but the invention is not limited thereto.

In an embodiment, the olefin reactant is, for example, (meth)acrylic acid, acrylic acid, or carboxyethyl acrylate (CEA), but the invention is not limited thereto.

Next, the olefin reactant is connected to a silicon reactant via a hydrosilylation reaction to obtain the silicon compound. In the present embodiment, the silicon reactant has at least one silane functional group.

In the present embodiment, the olefin reactant may be connected to the silicon reactant via a hydrosilylation reaction between a terminal olefin functional group thereof and the silane functional group (—SH) of the silicon reactant to obtain a silicon compound.

In an embodiment, the silicon reactant is represented by (R)₄₋ₙ—Si—(H)ₙ, wherein R is each independently a halogen atom, an alkyl group, an aryl group, an alkoxy group, or a hydroxyl group, and n is an integer of 1 to 4. In an embodiment, the silicon reactant has four silane functional groups (i.e., n is 4), that is, the silicon reactant having four silane functional groups (—SH) may be combined with four olefin reactants. In another embodiment, in addition to the silane functional groups (—SH), the silicon atom of the silicon reactant may be bonded with other substituents.

In an embodiment, the silicon reactant is, for example, a silicon material treated with hydrofluoric acid. In an embodiment, the silicon reactant is, for example, silicon nanoparticles treated with hydrofluoric acid. The silicon material treated with hydrofluoric acid (or the silicon nanoparticles) is etched on the surface to produce a silane functional group (—SH). The silane functional group of the silicon reactant may be hydrosilylated with the olefin functional group of the olefin reactant to graft an olefin compound having an olefin functional group at one terminal and a carboxyl group at another terminal to the silicon reactant to achieve the modification effect of the silicon reactant, and the resulting modified product is referred to as a polymer brush.

In the present embodiment, the hydrosilylation reaction of the olefin reactant and the silicon reactant is performed in the presence of a hydrosilylation catalyst and under conditions that promote hydrosilylation. In the present embodiment, the hydrosilylation catalyst is a metal complex that may increase the rate of the hydrosilylation reaction and/or transfer the equilibrium of the hydrosilylation reaction. In the present embodiment, a hydrosilylation catalyst compatible with the functional group on the reactant is selected. In an embodiment, the hydrosilylation catalyst is, for example, chloroplatinic acid, Pt-divinyl tetramethyldisiloxane complex (Pt-dvs), tris(triphenylphosphine) Rh (1) chloride, bis(diphenylphosphino)binapthyl palladium dichloride, or dicobalt dioctylcarbonyl, but the invention is not limited thereto. In the present embodiment, in order to promote the hydrosilylation reaction, the reaction temperature of the hydrosilylation reaction is higher than room temperature. In an embodiment, the reaction temperature of the hydrosilylation reaction is 40° C. to 100° C.

In the present embodiment, the molar number of unsaturated carbon (olefin functional group) of the olefin reactant in the reaction is greater than or equal to the molar number of the silane functional group of the silicon reactant in the reaction.

The second embodiment of the invention provides a preparation method of a silicon compound including the following steps. First, a first olefin reactant is provided, wherein the first olefin reactant includes a terminal olefin functional group, a group capable of reacting with the olefin functional group, and a linker connected to the terminal olefin functional group and the group capable of reacting with the olefin functional group.

In an embodiment, the linker of the first olefin reactant includes an alkylene group, an arylene group, a heteroarylene group, an alkyleneoxy group, a cycloalkylene group, an amide group, a carbonyloxy group, a divalent group having a halogen, or a combination thereof.

In an embodiment, the linker of the first olefin reactant is, for example, a C1 to C12 alkylene group, a C6 to C15 arylene group, a C2 to C12 heteroarylene group, a C1 to C12 alkyleneoxy group, a C3 to C12 cycloalkylene group, an amide group, a carbonyloxy group, or a divalent group having a halogen, but the invention is not limited thereto.

In the present embodiment, one terminal of the first olefin reactant has an olefin functional group that may be subjected to a hydrosilylation reaction with a silane functional group of the silicon reactant to bond the first olefin reactant with the silicon reactant. Another end of the first olefin reactant has a group capable of reacting with the olefin functional group, which may be reacted with an olefin functional group of a subsequent second olefin reactant, thereby connecting the second olefin reactant to the first olefin reactant. In the present embodiment, the group of the first olefin reactant capable of reacting with the olefin functional group is, for example, an alkyl halide group. In the present embodiment, the first olefin reactant is, for example, allyl-2-bromo-2-methylpropionate.

Then, the first olefin reactant is connected to the silicon reactant via a hydrosilylation reaction to obtain an intermediate product formed by bonding the first olefin reactant and the silicon reactant.

In an embodiment, the silicon reactant is represented by (R)₄₋ₙ—Si—(H)ₙ, wherein R is each independently a halogen atom, an alkyl group, an aryl group, an alkoxy group, or a hydroxyl group, and n is an integer of 1 to 4. In an embodiment, the silicon reactant has four silane functional groups (i.e., n is 4), that is, the silicon reactant having four silane functional groups (—SH) may be combined with four first olefin reactants. In another embodiment, in addition to the silane functional groups (—SH), the silicon atom of the silicon reactant may be bonded with other substituents.

In an embodiment, the silicon reactant is, for example, a silicon material treated with hydrofluoric acid. In an embodiment, the silicon reactant is, for example, silicon nanoparticles treated with hydrofluoric acid. The silicon material treated with hydrofluoric acid (or the silicon nanoparticles) is etched on the surface to produce a silane functional group (—SH).

In the present embodiment, the hydrosilylation reaction of the first olefin reactant and the silicon reactant is performed in the presence of a hydrosilylation catalyst and under conditions that promote hydrosilylation. In the present embodiment, the hydrosilylation catalyst is a metal complex that may increase the rate of the hydrosilylation reaction and/or transfer the equilibrium of the hydrosilylation reaction. In the present embodiment, a hydrosilylation catalyst compatible with the functional group on the reactant is selected. In an embodiment, the hydrosilylation catalyst is, for example, chloroplatinic acid, Pt-divinyl tetramethyldisiloxane complex (Pt-dvs), tris(triphenylphosphine) Rh (1) chloride, bis(diphenylphosphino)binapthyl palladium dichloride, or dicobalt dioctylcarbonyl, but the invention is not limited thereto. In the present embodiment, in order to promote the hydrosilylation reaction, the reaction temperature of the hydrosilylation reaction is higher than room temperature. In an embodiment, the reaction temperature of the hydrosilylation reaction is 40° C. to 100° C.

In the present embodiment, the molar number of unsaturated carbon (olefin functional group) of the first olefin reactant in the reaction is greater than or equal to the molar number of the silane functional group of the silicon reactant in the reaction.

Next, a second olefin reactant is brought in contact with the intermediate product such that the second olefin reactant is connected to the intermediate product to obtain the silicon compound. In the present embodiment, the second olefin reactant includes a terminal olefin functional group, a terminal carboxyl group, and a linker connected to the terminal olefin functional group and the terminal carboxyl group.

In an embodiment, the linker of the second olefin reactant includes an alkylene group, an arylene group, a heteroarylene group, an alkyleneoxy group, a cycloalkylene group, an amide group, a carbonyloxy group, a divalent group having a halogen, or a combination thereof.

In an embodiment, the linker of the second olefin reactant is, for example, a C1 to C12 alkylene group, a C6 to C15 arylene group, a C2 to C12 heteroarylene group, a C1 to C12 alkyleneoxy group, a C3 to C12 cycloalkylene group, an amide group, a carbonyloxy group, or a divalent group having a halogen, but the invention is not limited thereto.

In an embodiment, the second olefin reactant is, for example, (meth)acrylic acid, acrylic acid, or carboxyethyl acrylate.

In the present embodiment, the second olefin reactant may be connected to an intermediate product (specifically, the portion of the first olefin reactant in the intermediate product) via a reaction between the terminal olefin functional group thereof and a group capable of reacting with the olefin functional group of the intermediate product to obtain silicon oxide. For example, the second olefin reactant may be connected to an intermediate product via a reaction between the terminal olefin functional group thereof and a halogen atom of a halogenated alkyl group of the first olefin reactant.

In the present embodiment, when the group capable of reacting with the olefin functional group of the first olefin reactant is a halogenated alkyl group, a reaction catalyst may be further added such that a radical polymerization reaction may be performed at the same time the second olefin reactant is connected to the first olefin reactant. In the present embodiment, the reaction catalyst is, for example, copper bromide/2,2′-bipyridine (CuBr/Bipy).

In the present embodiment, when the silicon compound of the invention is used as an anode material of a lithium battery, and a polymer brush grafted on the silicon compound is used as an elastomer, the expansion after the reaction between silicon and lithium may be suppressed and the issue of material cracking may be reduced. In addition, the polymer brush grafted on the silicon compound may prevent excessive contact with an electrolyte solution, thereby reducing the issue of forming too many passive films due to electrolyte solution pyrolysis. Therefore, the internal resistance of the battery may be significantly reduced.

FIG. 1 is a cross-sectional diagram of a lithium battery according to an embodiment of the invention. Referring to FIG. 1, a lithium battery 100 includes an anode 102, a cathode 104, a separator 106, an electrolyte solution 108, and a package structure 112.

The anode 102 includes an anode metal foil 102a and an anode material 102b, wherein the anode material 102b is disposed on the anode metal foil 102a via coating or sputtering. The anode metal foil 102a is, for example, a copper foil, an aluminum foil, a nickel foil, or a high-conductivity stainless steel foil. In the present embodiment, the anode material 102b includes the silicon compound of the invention. In an embodiment, the anode material 102b may further include carbide or lithium metal. The carbide is, for instance, carbon powder, graphite, carbon fiber, carbon nanotube, graphene, or a mixture thereof. However, in other embodiments, the anode 102 may also only include the anode material 102b.

Based on a total weight of 100 parts by weight of the anode material 102b, the content of the silicon compound is 5 parts by weight to 85 parts by weight (preferably 10 parts by weight to 50 parts by weight).

The cathode 104 and the anode 102 are separately disposed. The cathode 104 includes a cathode metal foil 104a and a cathode material 104b, wherein the cathode material 104b is disposed on the cathode metal foil 104a via coating. The cathode metal foil 104a is, for example, a copper foil, an aluminum foil, a nickel foil, or a high-conductivity stainless steel foil. The cathode material 104b includes a lithium-mixed transition metal oxide. The lithium-mixed transition metal oxide is, for instance, LiMnO₂, LiMn₂O₄, LiCoO₂, Li₂Cr₂O₇, Li₂CrO₄, LiNiO₂, LiFeO₂, LiNiₓCo₁₋ₓO₂, LiFePO₄, LiMn_{0.5}Ni_{0.5}O₂, LiMn_{1/3}Co_{1/3}Ni_{1/3}O₂, LiMc_{0.5}Mn_{1.5}O₄, or a combination thereof, wherein 0<x<1 and Mc is a divalent metal.

Moreover, the lithium battery 100 may further include a polymer binder. The polymer binder is reacted with the anode 102 and/or the cathode 104 to increase the mechanical properties of the electrode. Specifically, the anode material 102b may be adhered to the anode metal foil 102a via the polymer binder, and the cathode material 104b may be adhered to the cathode metal foil 104a via the polymer binder. The polymer binder is, for instance, polyvinylidene difluoride (PVDF), styrene-butadiene rubber (SBR), polyamide, melamine resin, or a combination thereof.

The separator 106 is disposed between the anode 102 and the cathode 104, and the separator 106, the anode 102, and the cathode 104 define a housing region 110. The material of the separator 106 is an insulating material such as polyethylene (PE), polypropylene (PP), or a composite structure (such as PE/PP/PE) formed by the above materials.

The electrolyte solution 108 is disposed in the housing region 110. The electrolyte solution 108 includes an organic solvent, a lithium salt, and an additive. The amount of the organic solvent in the electrolyte solution 108 is 55 wt % to 90 wt %, the amount of the lithium salt in the electrolyte solution 108 is 10 wt % to 35 wt %, and the amount of the additive in the electrolyte solution 108 is 0.05 wt % to 10 wt %. However, in other embodiments, the electrolyte solution 108 may also not contain an additive.

The organic solvent is, for instance, γ-butyl lactone, ethylene carbonate (EC), propylene carbonate, diethyl carbonate (DEC), propyl acetate (PA), dimethyl carbonate (DMC), ethylmethyl carbonate (EMC), or a combination thereof.

The lithium salt is, for instance, LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, or a combination thereof.

The additive is, for instance, monomaleimide, polymaleimide, bismaleimide, polybismaleimide, a copolymer of bismaleimide and monomaleimide, vinylene carbonate (VC), or a mixture thereof. The monomaleimide is, for instance, selected from the group consisting of N-phenylmaleimide, N-(o-methylphenyl)-maleimide, N-(m-methylphenyl)-maleimide, N-(p-methylphenyl)-maleimide, N-cyclohexylmaleimide, maleimidophenol, maleimidobenzocyclobutene, phosphorus-containing maleimide, phosphonate-containing maleimide, siloxane-containing maleimide, N-(4-tetrahydropyranyl-oxyphenyl)maleimide, and 2,6-xylylmaleimide.

The package structure 112 covers the anode 102, the cathode 104, and the electrolyte solution 108. The material of the package structure 112 is, for example, aluminum foil.

It should be mentioned that, the anode 102 may be formed by adding the silicon compound of the invention in the anode material in a current battery manufacturing process. Therefore, the battery efficiency and charge and discharge cycle life of the lithium battery 100 may be effectively maintained without modifying any battery design or other electrode materials and electrolyte solutions, and the lithium battery 100 may have higher safety.

In the following, the effects of the silicon compound of the invention are described with experimental examples and comparative examples.

### Preparation of Silicon Compound

### Example 1: Preparation of Silicon Compound 1

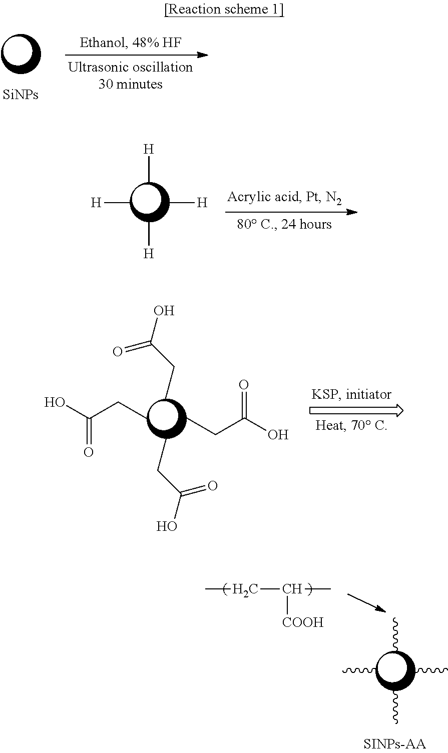

A 1.5 g sample of silicon nanoparticles (SiNPs) was dispersed in a polyethylene centrifuge tube filled with 20 mL of ethanol and subjected to ultrasonic oscillation using an ultrasonic water bath for 15 minutes. Then, 1.2 mL of a 48% hydrofluoric acid solution dissolved in 25 mL of deionized water was added to the above mixture, and the ultrasonic treatment was continued for 20 minutes. Then, solid powder was collected by continuous washing with ethanol and deionized water and centrifugation at a speed of 4000 rpm. The hydrogen-terminated silicon nanoparticles collected by centrifugation were dried in a vacuum oven at 80° C. overnight, and they were referred to as H-SiNPs and used as a silicon reactant.

Next, 0.8 g of H-SiNPs was added to 20 ml of ethanol and transferred to a round bottom flask. The round bottom flask contained 20% acrylic acid (160 mg) used as an olefin reactant and 4 mg of Pt-dvs used as a catalyst. The reaction mixture was refluxed at 70° C. under a stream of nitrogen. In the above process, acrylic acid and hydrogen-terminated silicon nanoparticles were subjected to a hydrosilylation reaction to graft acrylic acid onto the silicon nanoparticles. In order to further initiate the free radical polymerization of acrylic acid grafted on the surface of the silicon nanoparticles, 0.032 g of potassium persulfate (KPS) used as an initiator was dissolved in 5 mL of deionized water and the mixture was added to the above solution using a syringe. In-situ polymerization reaction was performed at 70° C. for 24 hours under the assistance of nitrogen to obtain silicon compound 1.

### Example 2: Preparation of Silicon Compound 2

A 1.5 g sample of silicon nanoparticles (SiNPs) was dispersed in a polyethylene centrifuge tube filled with 20 mL of ethanol and subjected to ultrasonic oscillation using an ultrasonic water bath for 15 minutes. Then, 1.2 mL of a 48% hydrofluoric acid solution dissolved in 25 mL of deionized water was added to the above mixture, and the ultrasonic treatment was continued for 20 minutes. Then, solid powder was collected by continuous washing with ethanol and deionized water and centrifugation at a speed of 4000 rpm. The hydrogen-terminated silicon nanoparticles collected by centrifugation were dried in a vacuum oven at 80° C. overnight, and they were referred to as H-SiNPs and used as a silicon reactant.

Next, 0.8 g of H-SiNPs was added to 20 ml of ethanol and transferred to a round bottom flask. The round bottom flask contained 30% carboxyethyl acrylate (248 mg) used as an olefin reactant and 4 mg of Pt-dvs used as a catalyst. The reaction mixture was refluxed at 70° C. under a stream of nitrogen. In the above process, acrylic acid and hydrogen-terminated silicon nanoparticles were subjected to a hydrosilylation reaction to graft acrylic acid onto the silicon nanoparticles. In order to further initiate the free radical polymerization of acrylic acid grafted on the surface of the silicon nanoparticles, 0.032 g of potassium persulfate (KPS) used as an initiator was dissolved in 5 mL of deionized water and the mixture was added to the above solution using a syringe. In-situ polymerization reaction was performed at 70° C. for 24 hours under the assistance of nitrogen to obtain silicon compound 2.

### Example 3: Preparation of Silicon Compound 3

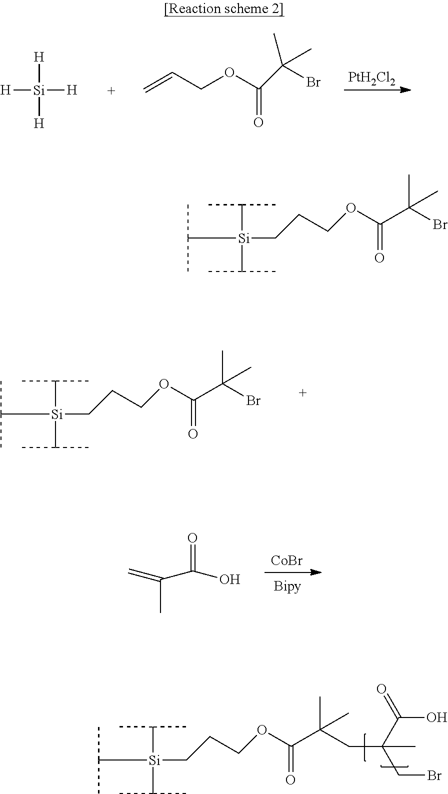

A 0.5 g sample of silicon nanoparticles (SiNPs) was dispersed in a polyethylene centrifuge tube filled with 20 mL of ethanol and subjected to ultrasonic oscillation using an ultrasonic water bath for 15 minutes. Then, 1.2 mL of a 48% hydrofluoric acid solution dissolved in 25 mL of deionized water was added to the above mixture, and the ultrasonic treatment was continued for 20 minutes. Then, solid powder was collected by continuous washing with ethanol and deionized water and centrifugation at a speed of 4000 rpm. The hydrogen-terminated silicon nanoparticles collected by centrifugation were dried in a vacuum oven at 80° C. overnight, and they were referred to as H-SiNPs and used as a silicon reactant.

Next, 0.8 g of H-SiNPs was added to 7 ml of tetrahydrofuran (THF) and transferred to a round bottom flask. The round bottom flask contained 4 μL of allyl-2-bromo-2-methylpropionate as a first olefin reactant and 4 mg of Pt-dvs as a catalyst. The reaction mixture was reacted in a stream of nitrogen at 60° C. for 24 hours, and the product was referred to as a SiNPs-macroinitiator. In the above process, the first olefin reactant and the hydrogen-terminated silicon nanoparticles were subjected to a hydrosilylation reaction to graft the first olefin reactant onto the silicon nanoparticles.

Then, 0.32 g of SiNPs-macromolecule starting material, 1 g of acrylic acid, and 60 mg of Bipy were first mixed, and then 20 mg of CuBr was added to the mixture that was then subjected to a radical polymerization reaction at room temperature for 24 hours. The obtained product was washed with EDTA and ethanol and dried in an oven to obtain silicon compound 3.

### Example 4

[Preparation of Anode]

Silicon compound 1, carbon black (Super-P) used as a conductive agent, and carboxymethyl cellulose sodium salt (CMC-Na) used as a binder were mixed at a weight ratio of 60:20:20. First, a binder material was stirred in an aqueous solvent at 600 rpm for 24 hours using a magnetic stirrer. Next, an aqueous solution of the anode active material (that is, silicon compound 1), Super-P, and CMC-Na was mixed at 600 rpm using a magnetic stirrer for 12 hours to prepare a slurry. Then, the prepared slurry was coated in a fresh copper foil using a 100 μm doctor blade and dried under vacuum at 90° C. for 3 hours, and then dried at 100° C. in a vacuum oven overnight. Then, the dried electrode was pressed in a rolling mill to stabilize the contact between the substrate and the current collector. At this point, the anode of the present embodiment was obtained.

[Preparation of Cathode]

The cathode of the present application is a lithium metal sheet.

[Preparation of Electrolyte Solution]

LiPF₆ was dissolved in a mixed solution of propylene carbonate (PC), ethylene carbonate (EC), and diethyl carbonate (DEC) (volume ratio: PC/EC/DEC=2/3/5) to prepare an electrolyte solution having a concentration of 1 M, wherein the mixed solution was used as an organic solvent in the electrolyte solution, and LiPF₆ was used as lithium salt in the electrolyte solution.

[Manufacture of Lithium Battery]

After polypropylene was used as a separator to isolate the anode and the cathode and define the housing region, the electrolyte solution was added in the housing region between the anode and the cathode. Lastly, the above structure was sealed with a package structure to complete the manufacture of the lithium battery of Example 4.

### Example 5

The anode, cathode, electrolyte solution, and lithium battery of Example 5 were prepared according to a preparation procedure similar to that of Example 1. The only difference was that in the anode of Example 5, the anode active material used was silicon compound 2 and not silicon compound 1.

### Example 6

The anode, cathode, electrolyte solution, and lithium battery of Example 6 were prepared according to a preparation procedure similar to that of Example 1. The only difference was that in the anode of Example 6, the anode active material used was silicon compound 3 and not silicon compound 1.

### Comparative Example 1

The anode, cathode, electrolyte solution, and lithium battery of Comparative example 1 were prepared according to a preparation procedure similar to that of Example 1. The only difference was that in the anode of Comparative example 1, the anode active material used was unmodified raw silicon nanoparticles and not silicon compound 1.

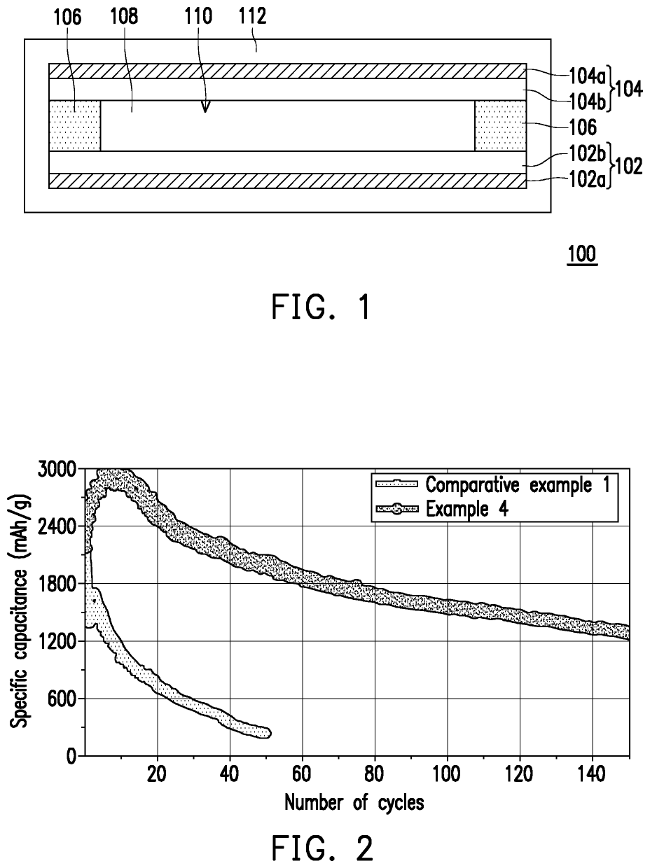

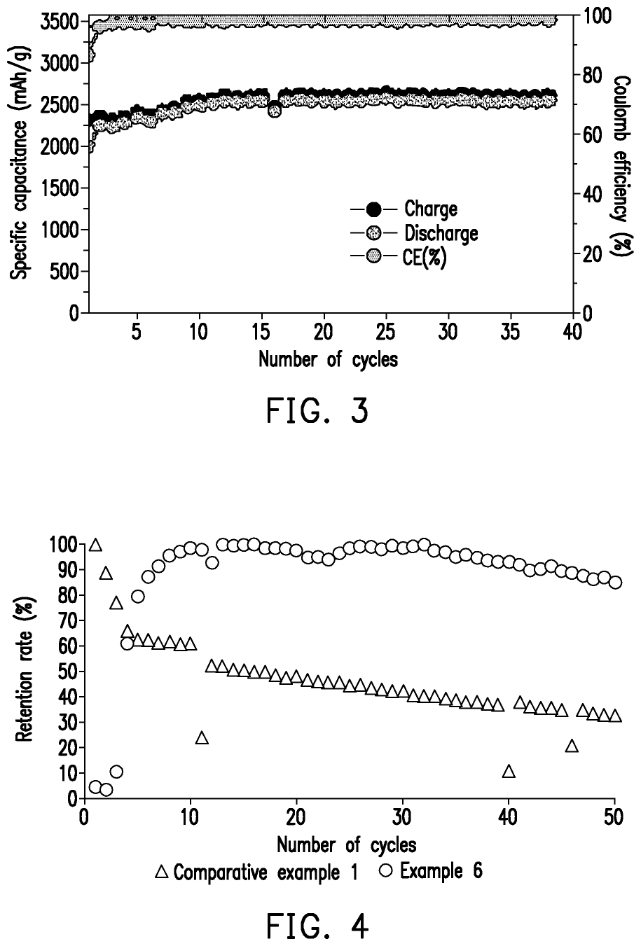

Next, the lithium batteries of Example 4, Example 5, Example 6, and Comparative example 1 were subjected to a cycle life test. FIG. 2 is a life cycle diagram of the lithium batteries of Experimental example 4 and Comparative example 1. FIG. 3 is a life cycle diagram of the lithium battery of Experimental example 5. FIG. 4 is a life cycle diagram of the lithium batteries of Experimental example 6 and Comparative example 1.

As may be clearly seen from FIG. 2 to FIG. 4, compared with the lithium battery (that is, Comparative example 1) having the unmodified raw silicon nanoparticles, when the lithium battery has the silicon compound of the invention (that is, Experimental example 4 to Experimental example 6), the cycle life of the lithium batteries of Experimental example 4 to Experimental example 6 is significantly higher than that of Comparative example 1, indicating that the silicon compound of the invention may effectively improve battery performance. Specifically, when the silicon compound of the invention is used as an anode material of a lithium battery, the polymer brush grafted on the silicon compound may be used as an elastomer and a negatively-charged functional group. As a result, the slurry is readily dispersed and the expansion after the reaction between silicon and lithium may be suppressed, and the issue of material cracking may be reduced. In addition, the polymer brush grafted on the silicon compound may prevent excessive contact with the electrolyte solution, thereby reducing the issue of forming too many passive films due to electrolyte solution pyrolysis. Therefore, the internal resistance of the battery may be significantly reduced, thereby improving the life of lithium batteries.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A silicon compound represented by the following Chemical formula 1:
(R¹)₄₋ₙ—Si-(L-A)ₙ [Chemical formula 1]
in Chemical formula 1,
L is a linker,
A is a carboxyl group,
R¹ is each independently hydrogen, a halogen atom, an alkyl group, an aryl group, an alkoxy group, or a hydroxyl group,
n is an integer of 0 to 4,
when n is greater than or equal to 2, L may be the same or different group.

2. The silicon compound of claim 1, wherein the linker comprises an alkylene group, an arylene group, a heteroarylene group, an alkyleneoxy group, a cycloalkylene group, an amide group, a carbonyloxy group, a divalent group having a halogen, or a combination thereof.

3. A preparation method of a silicon compound, comprising:
providing an olefin reactant; and
connecting the olefin reactant to a silicon reactant via a hydrosilylation reaction to obtain the silicon compound,
wherein the silicon reactant has at least one silane functional group,
wherein the olefin reactant comprises a terminal olefin functional group, a terminal carboxyl group, and a linker connected to the terminal olefin functional group and the terminal carboxyl group.

4. The preparation method of the silicon compound of claim 3, wherein the silicon reactant is represented by (R)₄₋ₙ—Si—(H)ₙ,
wherein R is each independently a halogen atom, an alkyl group, an aryl group, an alkoxy group, or a hydroxyl group,
n is an integer of 1 to 4.

5. The preparation method of the silicon compound of claim 3, wherein the linker comprises an alkylene group, an arylene group, a heteroarylene group, an alkyleneoxy group, a cycloalkylene group, an amide group, a carbonyloxy group, a divalent group having a halogen, or a combination thereof.

6. The preparation method of the silicon compound of claim 3, wherein the olefin reactant comprises (meth)acrylic acid, acrylic acid, or carboxyethyl acrylate.

7. A preparation method of a silicon compound, comprising:
providing a first olefin reactant;
connecting the first olefin reactant to a silicon reactant via a hydrosilylation reaction to obtain an intermediate product; and
bringing a second olefin reactant in contact with the intermediate product such that the second olefin reactant is connected to the intermediate product to obtain the silicon compound,
wherein the silicon reactant has at least one silane functional group,
wherein the first olefin reactant comprises a first terminal olefin functional group, a group capable of reacting with the olefin functional group, and a first linker connected to the first terminal olefin functional group and the group capable of reacting with the olefin functional group, and
the second olefin reactant comprises a second terminal olefin functional group, a terminal carboxyl group, and a second linker connected to the second terminal olefin functional group and the terminal carboxyl group.

8. The preparation method of the silicon compound of claim 7, wherein the silicon reactant is represented by (R)₄₋ₙ—Si—(H)ₙ,
wherein R is each independently a halogen atom, an alkyl group, an aryl group, an alkoxy group, or a hydroxyl group,
n is an integer of 1 to 4.

9. The preparation method of the silicon compound of claim 7, wherein the first linker comprises an alkylene group, an arylene group, a heteroarylene group, an alkyleneoxy group, a cycloalkylene group, an amide group, a carbonyloxy group, a divalent group having a halogen, or a combination thereof.

10. The preparation method of the silicon compound of claim 7, wherein the second linker comprises an alkylene group, an arylene group, a heteroarylene group, an alkyleneoxy group, a cycloalkylene group, an amide group, a carbonyloxy group, a divalent group having a halogen, or a combination thereof.

11. The preparation method of the silicon compound of claim 7, wherein the group capable of reacting with the olefin functional group comprises an alkyl halide group.

12. The preparation method of the silicon compound of claim 7, wherein the first olefin reactant comprises allyl-2-bromo-2-methylpropionate.

13. The preparation method of the silicon compound of claim 7, wherein the second olefin reactant comprises (meth)acrylic acid, acrylic acid, or carboxyethyl acrylate.

14. A lithium battery, comprising:
a cathode;
an anode disposed separately from the cathode, wherein the anode comprises the silicon compound of claim 1;
a separator disposed between the cathode and the anode, wherein the separator, the cathode, and the anode define a housing region;
an electrolyte solution disposed in the housing region; and
a package structure covering the cathode, the anode, and the electrolyte solution.

15. The lithium battery of claim 14, wherein the electrolyte solution comprises an organic solvent, lithium salt, and an additive.

16. The lithium battery of claim 15, wherein the additive comprises monomaleimide, polymaleimide, bismaleimide, polybismaleimide, a copolymer of bismaleimide and monomaleimide, vinylene carbonate, or a mixture thereof.

17. A lithium battery, comprising:
a cathode;
an anode disposed separately from the cathode, wherein the anode comprises the silicon compound of claim 2;
a separator disposed between the cathode and the anode, wherein the separator, the cathode, and the anode define a housing region;
an electrolyte solution disposed in the housing region; and
a package structure covering the cathode, the anode, and the electrolyte solution.

18. The lithium battery of claim 17, wherein the electrolyte solution comprises an organic solvent, lithium salt, and an additive.

19. The lithium battery of claim 17, wherein the additive comprises monomaleimide, polymaleimide, bismaleimide, polybismaleimide, a copolymer of bismaleimide and monomaleimide, vinylene carbonate, or a mixture thereof.
